(19) United States
(12) Patent Application Publication
(10) Pub. No.: US 2018/0075988 A1
(43) Pub. Date: Mar. 15, 2018

(54) KEY STRUCTURE, MANUFACTURING METHOD THEREOF, AND KEYBOARD DEVICE USING THE SAME

(71) Applicant: PRIMAX ELECTRONICS LTD., Taipei (TW)

(72) Inventors: Chun-Yuan Liu, Taipei (TW); Wei-Yung Huang, Taipei (TW)

(21) Appl. No.: 15/348,754

(22) Filed: Nov. 10, 2016

(30) Foreign Application Priority Data
Sep. 14, 2016 (TW) 105130010

(51) Int. Cl. H01H 13/83; H01H 13/02; H01H 11/00; H01H 13/14

(52) U.S. Cl. CPC H01H 13/83; H01H 13/023; H01H 11/0056; H01H 2239/056; H01H 2219/036; H01H 2229/044; H01H 2231/002; H01H 13/14

(57) ABSTRACT

The present invention provides a key structure and a manufacturing method thereof. The key structure includes a keycap made of a first material and a graphics made of a second material. A part of the graphics is filled in a groove that extends downwards from an upper surface of the keycap, and an other part of the graphics is exposed outside the groove for press, and the graphics is molded by means of a resin dispensing process. In addition, the present invention further provides a keyboard devices that applies the foregoing key structure.

### FIELD OF THE INVENTION

The present invention relates to the field of input devices, and more particularly to a key structure and a manufacturing method thereof, and a keyboard device using the key structure.

### BACKGROUND OF THE INVENTION

With the constant progress of science and technology of the modern society, electronic products are widely applied to daily life, and key structures applied to the electronic products not only need to match various electronic products, but also constantly develop towards aspects such as manufacturing cost reduction and process improvement, so as to improve the product competitiveness. In addition, common peripheral input devices of a computer include a mouse device, a keyboard device, a trackball device, and the like, where the keyboard device including a key structure is quite appreciated because the keyboard device can help a user directly enter text and symbols into the computer.

Referring to FIG. 1, FIG. 1 is a structural top view of a current keyboard device. A keyboard device 1 includes a keyboard base 11, a plurality of key structures 12, and key switches respectively corresponding to the plurality of key structures 12 (not shown). The keyboard base 11 bears the key structures 12 and the key switches, and the key structures 12 move downwards relative to the keyboard base 11 for press. When any key structure 12 is pressed and moves downwards to resist against the corresponding key switch located below the key structure 12, the key switch generates and outputs a key signal to a computer connected to the keyboard device (not shown), so as to drive the computer to execute a corresponding instruction.

Referring to FIG. 2, FIG. 2 is a schematic structural diagram of a key structure of the keyboard device shown in FIG. 1. The key structure 12 includes a keycap 121, and text or a graph 1211 for identification during operation by a user is printed on an upper surface of the keycap 121, and UV curable resin 1212 is further coated on the text and graph 1211, so as to provide a scratch-resistant effect. However, a disadvantage of the current key structure 12 lies in that the upper surface of the keycap 121 is excessively smooth, and the text or graph 1211 thereof cannot be stereoscopic, and consequently, a user cannot identify the key structure 12 by means of hand feelings during operation.

Further, when the current key structure 12 is applied to a light emitting keyboard, the text or graph 1211 located on the upper surface of the keycap 121 particularly needs to perform light transmission processing, so that light beams provided by a light emitting element (not shown) provided in the keyboard device 1 are output outwards, and in view of the limitation of the manufacturing process of the current keycap 121, colors of light beams output from same text or a same graph are same, and it is not easy to assist in visual identification by means of colorful pattern presentation, for example, four blocks of the graph 1211 (a Windows logo) shown in FIG. 2 cannot individually present light beams of different colors.

According to the foregoing description, it can be known that the current key structure 12 and keyboard device 1 have a space for improvement.

### SUMMARY OF THE INVENTION

A first object of the present invention lies in providing a key structure, and more particularly to a key structure whose graphics is stereoscopic to improve identification.

A second object of the present invention lies in providing a method for manufacturing a key structure, and more particularly to a manufacturing method of forming a graphics at a groove of a keycap thereof by means of a resin dispensing process.

A third object of the present invention lies in providing a keyboard device that applies the foregoing key structure.

In a preferable embodiment, the present invention provides a keyboard device, including:

a keyboard base;

a plurality of key structures, which is provided on the keyboard base, and is used to move up and down relative to the keyboard base, and each of the key structures comprises:

a keycap, which is made of a first material, and includes a groove that extends downwards from an upper surface of the keycap; and

a graphics, which is made of made of a second material, and a part of the graphics is filled in the groove, and an other part of the graphics is exposed outside the groove; and

a plurality of key switches, which respectively corresponds to the plurality of key structures, and any one of the plurality of key switches generates and outputs a corresponding key signal in responding to the press on the graphics of the corresponding key structure.

In a preferable embodiment, the present invention also provides a key structure, including:

a keycap, which is made of a first material, and includes a groove that extends downwards from an upper surface of the keycap; and

a graphics, which is made of a second material, which is different from the first material, and a part of the graphics is filled in the groove, and an other part of the graphics is exposed outside the groove for press.

In a preferable embodiment, the present invention also provides a method for manufacturing a key structure, including:

forming a keycap having a groove by means of an injection process, where the groove extends downwards from an upper surface of the keycap; and

forming a graphics at the groove by means of a resin dispensing process, and at least a part of the graphics is exposed outside the groove.

### BRIEF DESCRIPTION OF THE DRAWINGS

FIG. 1 is a structural top view of a current keyboard device.

FIG. 2 is a schematic structural diagram of a key structure of the keyboard device shown in FIG. 1.

FIG. 3 is a structural top view of a preferable embodiment of a keyboard device of the present invention.

FIG. 4 is a schematic structural diagram of a key structure of the keyboard device shown in FIG. 3.

FIG. 5 is a schematic stereoscopic breakdown diagram of the key structure shown in FIG. 4.

FIG. 6 is a flowchart of a preferable method of a method for manufacturing a key structure of the present invention.

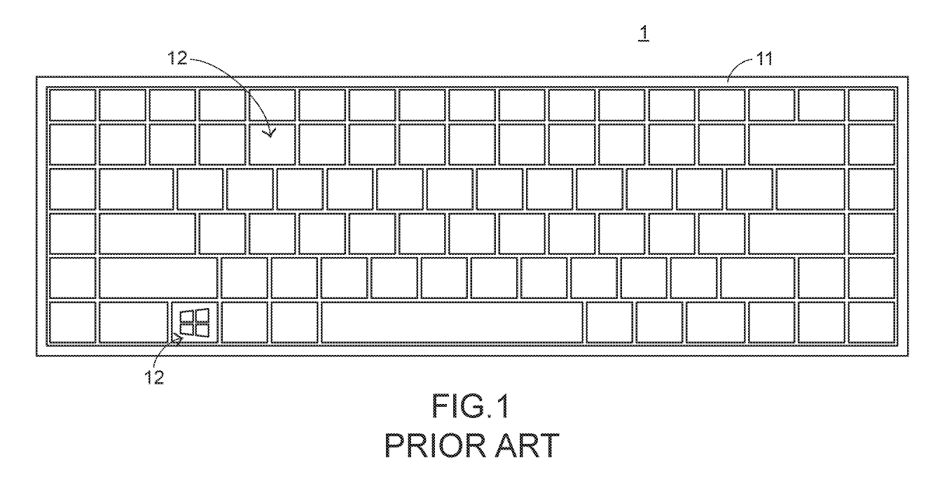

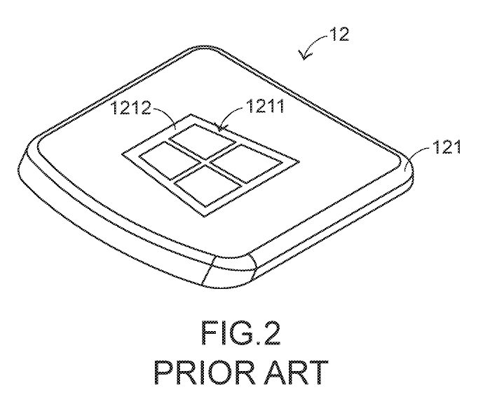

### DETAILED DESCRIPTION OF THE PREFERRED EMBODIMENT

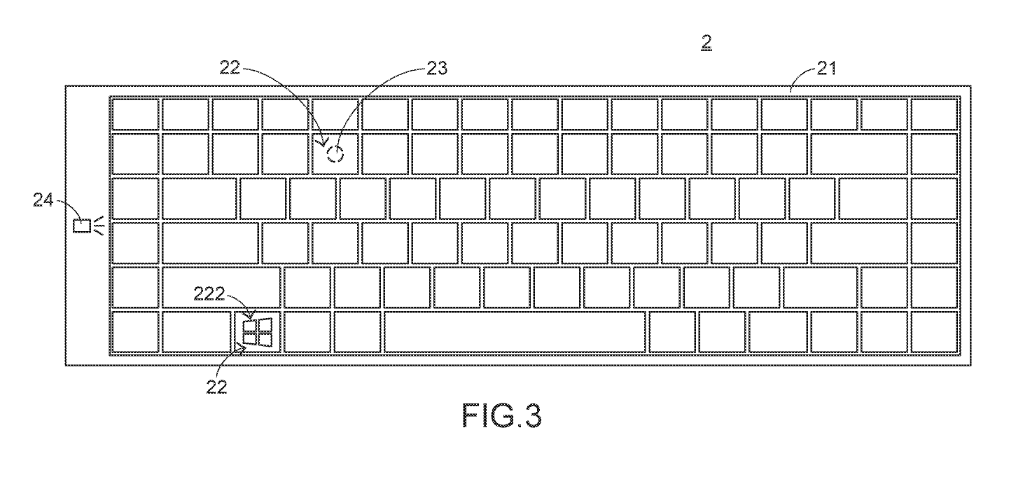

Referring to FIG. 3, FIG. 3 is a structural top view of a preferable embodiment of a keyboard device of the present invention. A keyboard device 2 includes a keyboard base 21, a plurality of key structures 22, and key switches 23 respectively corresponding to the plurality of key structures 22 (for clearer illustration, FIG. 3 only draws a single key switch 23 shown by the dash line). The keyboard base 21 bears the key structures 22 and the key switches 23, and the key structures 22 provided on the keyboard base 21 are used to move up and down relative to the keyboard base 21. When any key structure 22 is pressed and moves downwards to resist against the corresponding key switch 23 located below the key structure 22, the key switch 23 generates and outputs a key signal to an electronic device connected to the keyboard device 2 (not shown, for example, a computer), so as to drive the electronic device to execute a corresponding instruction.

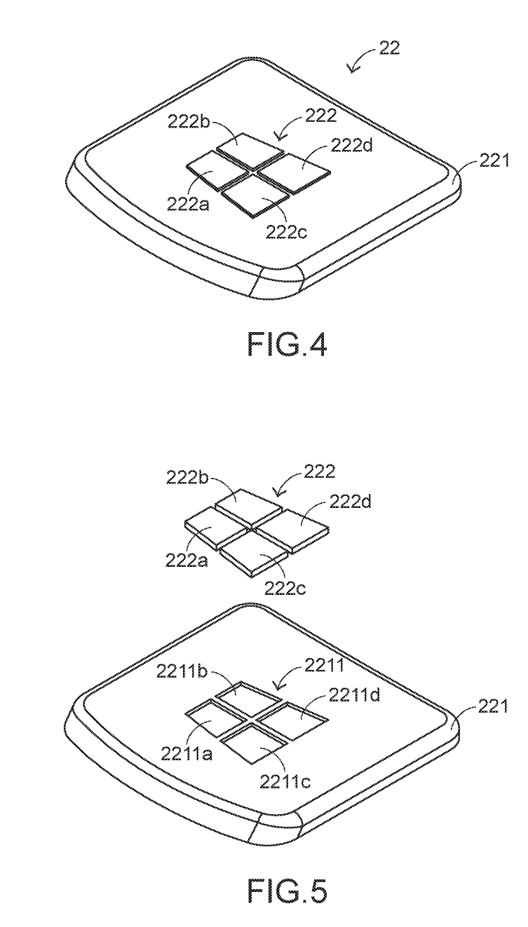

Referring to FIG. 4 and FIG. 5, FIG. 4 is a schematic structural diagram of a key structure of the keyboard device shown in FIG. 3, and FIG. 5 is a schematic stereoscopic breakdown diagram of the key structure shown in FIG. 4. The key structure 22 includes a keycap 221 and a plurality of graphics 222, and the keycap 221 is made of a first material, and includes a plurality of grooves 2211 that extends downwards from an upper surface of the keycap 221 and respectively corresponds to the graphics 222. The graphics 222 are made of a second material, and a part of each graphics 222 is filled into the corresponding groove 2211, and an other part of each graphics 222 is exposed outside the corresponding groove 2211 for press. It is supplemented that for clearer illustration, FIG. 3 only draws the graphics 222 on the single key structure 22, and makes further description with reference to FIG. 4.

Each graphics 222 may be in a typeface shape or a geometrical shape, and is mainly used to mark the key structure 22. As regards FIG. 4, the graphics 222 form a Windows logo, so as to mark the key structure 22 shown in FIG. 4 as a Windows logo key. However, because some of the graphics 222 protrude outside the grooves 2211 to provide a stereoscopic presentation sense, a user can identify the key structure 22 by means of hand feelings of pressing the graphics 222 during the operation.

Further, in this preferable embodiment, the first material for manufacturing the keycap 221 is different from the second material for manufacturing the graphics 222, so as to improve the capability of the user of identifying the key structure 22 by touching the graphics 222. The first material may be a polycarbonate (PC) material or an ABS (Acrylonitrile Butadiene Styrene) material, and the second material may be a polyvinyl chloride (PVC) material or a polysiloxane material. However, the foregoing is only an embodiment, and a person skilled in the art can use suitable materials to manufacture the keycap 221 and the graphics 222 according to actual application requirements.

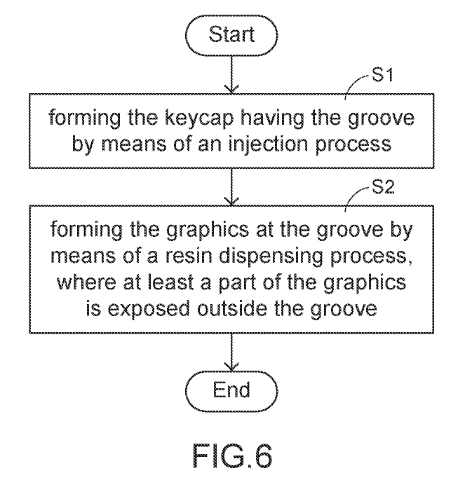

Referring to FIG. 6, FIG. 6 is a flowchart of a preferable method of a method for manufacturing a key structure of the present invention. A method for manufacturing the key structure 22 includes: step S1, forming the keycap 221 having the groove 2211 by means of an injection process; and step S2, forming the graphics 222 at the groove 2211 by means of a resin dispensing process, where at least a part of the graphics 222 is exposed outside the groove 2211. The resin dispensing process is also called a micro-injection process, which mainly injects the second material to the keycap 221 from an injector (not shown) by compressing air, and then enables the second material to be cured into the graphics 222 by means of heat processing. Therefore, the material with good flowability in a liquid state should be selected as the second material, so as to be more advantageous to manufacturing the graphics 222. However, specific implementation technologies about the resin dispensing process are known by a person skilled in the art, and therefore details are not described again herein.

In addition, in the resin dispensing process, the injector is first moved by a machine to be actually positioned and then injects the second material to the keycap 221. Therefore, after the machine moves the injector for a plurality of times because of the shape of the graphics 222 and completes work of injecting the second material, the graphics 222 is initially molded so as to be cured by heat processing. However, it is particularly noted that the reason why this application designs to form the groove 2211 on the keycap 221 lies in enabling the second material to be fixed in the groove 2211 without spill and dispersal after the second material is injected into the keycap 221, that is, the second material injected into the keycap 221 is filled in the groove 2211. Therefore, in this application, the shape of the groove 2211 is designed corresponding to the shape of the graphics 222.

Preferably, but not limited thereto, the keyboard device 2 shown in FIG. 3 is the keyboard device 2 including a light emitting element 24, and the light emitting element is provided in the keyboard base 21 and is used to provide light beams. However, the second material for manufacturing the graphics 222 uses a light transmissive material, and the groove 2211 of the keycap 221 is transparent. Therefore, light beams provided by the light emitting element 24 can be output outwards after passing through the graphics 222 on the key structure 22, where the light transmittance of the light transmissive material is determined according to actual application requirements.

Further, in this preferable embodiment, the plurality of graphics 222 of the key structure 22 shown in FIG. 4 is respectively manufactured by the second material having different colors. That is, in the resin dispensing process, the machine drives the injector to respectively inject the second material having different colors into different grooves 2211a to 2211d, and therefore after light beams provided by the light emitting element 24 respectively pass through the graphics 222a to 222d and are output outwards, the keycap 221 of the key structure 22 may present a windows flag in a colorful pattern, so that a user can further identify a location of a Windows logo key by means of user's eye in a use environment with insufficient luminance.

According to the foregoing description, it can be known that the key structure of the present invention can improve the capability of a user for identifying the key structure by means of hand feelings of operation because the key structure has stereoscopic graphics, and when applied to a light emitting keyboard, the key structure can also assist the light emitting keyboard in generating color light beams to improve visual identification of the user, and therefore has extremely high industrial use value. In addition, although in the foregoing embodiments, the key structure is applied to the keyboard device, a person skilled in the art, according to the teaching obtained by the foregoing embodiments, can apply the key structure of the present invention to other various electronic devices for control use, for example, a remote control or a vehicle control panel.

The foregoing embodiments are only preferable embodiments of the present invention; however, these embodiments are not intended to limit the application patent scope of the present invention. Therefore, other equivalent changes or modifications made without departing from the spirit disclosed by the present invention shall fall within the application patent scope of the present invention.

What is claimed is:

1. A keyboard device, comprising:
a keyboard base;
a plurality of key structures, which is provided on the keyboard base, and is used to move up and down relative to the keyboard base, and each of the key structures comprises:
a keycap, which is made of a first material, and comprises a groove that extends downwards from an upper surface of the keycap; and
a graphics, which is made of a second material, and a part of the graphics is filled in the groove, and an other part of the graphics is exposed outside the groove; and
a plurality of key switches, which respectively corresponds to the plurality of key structures, and any one of the plurality of key switches generates and outputs a corresponding key signal in responding to a press on the graphics of the corresponding key structure.

2. The keyboard device according to claim 1, further comprising at least one light emitting element, and the second material is a light transmissive material, wherein light beams provided by the at least one light emitting device pass through the graphics of the at least one key structure and then are output outwards.

3. The key structure according to claim 1, wherein the graphics is in a typeface shape or a geometrical shape.

4. The keyboard device according to claim 1, wherein the groove is molded by means of an injection process.

5. The keyboard device according to claim 1, wherein the graphics is molded by means of a resin dispensing process.

6. The keyboard device according to claim 1, wherein the first material is a polycarbonate (PC) material or an ABS (Acrylonitrile Butadiene Styrene) material.

7. The keyboard device according to claim 1, wherein the second material is a polyvinyl chloride (PVC) material or a polysiloxane material.

8. A key structure, comprising:
a keycap, which is made of a first material, and comprises a groove that extends downwards from an upper surface of the keycap; and
a graphics, which is made of a second material, which is different from the first material, and a part of the graphics is filled in the groove, and an other part of the graphics is exposed outside the groove for press.

9. The key structure according to claim 8, wherein the graphics is in a typeface shape or a geometrical shape.

10. The key structure according to claim 8, wherein the groove is molded by means of an injection process.

11. The key structure according to claim 8, wherein the graphics is molded by means of a resin dispensing process.

12. The key structure according to claim 8, wherein the first material is a polycarbonate (PC) material or an ABS (Acrylonitrile Butadiene Styrene) material.

13. The key structure according to claim 8, wherein the second material is a polyvinyl chloride (PVC) material or a polysiloxane material.

14. The key structure according to claim 8, wherein the second material is a light transmissive material.

15. The key structure according to claim 8, wherein the key structure is applied to a keyboard device or a remote control.

16. A method for manufacturing a key structure, comprising:
forming a keycap having a groove by means of an injection process, wherein the groove extends downwards from an upper surface of the keycap; and
forming a graphics at the groove by means of a resin dispensing process, and at least a part of the graphics is exposed outside the groove.

17. The method for manufacturing a key structure according to claim 16, wherein the keycap and the graphics are made of a first material and a second material respectively, and the second material is different from the first material.

18. The method for manufacturing a key structure according to claim 16, wherein the keycap is made of an ABS (Acrylonitrile Butadiene Styrene) material or a polycarbonate (PC) material.

19. The method for manufacturing a key structure according to claim 16, wherein the graphics is made of a polyvinyl chloride (PVC) material or a polysiloxane material.

20. The method for manufacturing a key structure according to claim 8, wherein the graphics is made of a light transmissive material.
